(19) United States
(12) Patent Application Publication
(10) Pub. No.: US 2023/0014429 A1
(43) Pub. Date: Jan. 19, 2023

(54) APPARATUS AND METHOD FOR THE PRESERVATION, STORAGE AND/OR SHIPMENT OF LIQUID-EXUDING PRODUCTS

(71) Applicant: CSP Technologies, Inc., Auburn, AL (US)

(72) Inventors: Derek Riley, Live Oak, FL (US); Michael A. Johnston, Marietta, GA (US); Neal D. Watson, Atlanta, GA (US); John Belfance, Phenix, AL (US); Jonathan R. Freedman, Auburn, AL (US); Deepti S. Gupta, Glenn Allen, VA (US); Franklin Lee Lucas, JR., Opelika, AL (US); Jason Pratt, Auburn, AL (US); Kathryn Perko, Auburn, AL (US); G.F. Alexia Gleason, Madison, WI (US); Ethan Ross Perdue, Auburn, AL (US); James S. Hollinger, Auburn, AL (US)

(21) Appl. No.: 17/934,624

(22) Filed: Sep. 23, 2022

Related U.S. Application Data
(63) Continuation of application No. 17/095,512, filed on Nov. 11, 2020.
Application No. 17/095,512 is a continuation of application No. PCT/US2018/067591, filed on Dec. 27, 2018.
(60) Provisional application No. 62/670,610, filed on May 11, 2018.

(51) Int. Cl. B65D 81/26; A23B 4/16; A23B 7/152; B65B 25/00; B65B 25/04; B65B 25/06

(52) U.S. Cl. CPC B65D 81/265; A23B 4/16; A23B 7/152; B65B 25/001; B65B 25/041; B65B 25/062; B65B 25/067; A23V 2002/00

(57) ABSTRACT

Apparatuses and methods are provided for storing and preserving product, such as to extend shelf life of the same. In one optional method, liquid-exuding product is placed in a product containing space of a container atop a platform of a support structure. The container can include an internal compartment having the product containing space. The structure can define the platform for supporting the product. The internal compartment can further include a reservoir, configured to retain liquid, below the platform. At least one of the platform or the support structure can be configured to direct liquid exuded from the product to the reservoir. Optionally, the reservoir comprises or contains an absorbent material for absorbing liquid in the reservoir.

### CROSS-REFERENCE TO RELATED APPLICATION

This application claims priority to U.S. Provisional Patent Application No. 62/670,610, entitled APPARATUS AND METHOD FOR THE PRESERVATION, STORAGE AND/OR SHIPMENT OF LIQUID-EXUDING PRODUCTS and filed on May 11, 2018, which is hereby incorporated by reference in its entirety.

### FIELD OF THE PRESENTLY DISCLOSED TECHNOLOGY

The disclosed concept relates generally to systems, apparatuses and methods for packaging and preserving liquid-exuding product (e.g., comestibles) (hereinafter “product”). More particularly, the disclosed concept relates to use of packaging for product. Packaging according to the disclosed concept has been found to improve shelf life of such products.

### BACKGROUND

Standard bulk packaging for products are typically achieved using metal or plastic cans, trays or tubs. Other products are often packaged in mesh bags. Liquids exuded by products, for example, tend to pool in the bottom of conventional packaging. In this manner, products in a conventional package will often sit within their own exudate, which causes the products to quickly degrade. Fresh products packaged in this manner and stored at a temperature above freezing may not last a relatively long time. In addition, the products may often be discolored and present an unpleasant odor. In the case of live products, storage of such products in conventional packages typically results in a significant percentage of them dying relatively early.

### SUMMARY

Short shelf life is a significant problem with some products because by the time products reach the shelves for wholesale or retail purchase, they have typically already lost a good portion of their useful life between packaging, warehousing and/or shipping. Accordingly, there is a strong need for improved packaging for products, which extends the shelf life.

Accordingly, in one optional embodiment, a method of packaging and preserving products is provided. The method includes placing the products in a product containing space of a storage container atop a platform of a support structure. The storage container includes an internal compartment having the product containing space, the support structure defining the platform for supporting the products. The internal compartment further includes a reservoir below (and, thus, at least slightly spaced-apart from) the platform. The reservoir is configured to retain or at least temporarily liquid. The platform and/or support structure are configured to direct liquid exuded from the products to the reservoir.

In another optional embodiment, a method of packaging and preserving products is provided. The method includes providing a storage container that defines an internal compartment. The internal compartment includes a reservoir and a product containing space above the reservoir. The storage container includes a base and a sidewall extending upwardly from the base, the base and at least a portion of the sidewall extending therefrom defining the reservoir. The reservoir is configured to retain liquid. A support structure is disposed within the internal compartment, the support structure defining a platform located above the reservoir. The support structure and/or platform include one or more of: a liquid permeable surface; one or more openings; and a ramp providing for liquid runoff from a side of the platform. The one or more of the liquid permeable surface, the one or more openings and the ramp, are configured to direct liquid exuded from the products into the reservoir. The method further includes placing the products in the storage container atop the platform.

Optionally, in any embodiment, the storage container is formed from a thermoformed polymer tray. Optionally, in any embodiment, the storage container is formed from a material other than a polymer.

Optionally, in any embodiment, an absorbent material is provided in the reservoir. Optionally, the absorbent material includes a gel-forming polymer.

Optionally, in any embodiment, the reservoir is devoid of an absorbent material.

Optionally, in any embodiment, a lid encloses the products within the product containing space. Optionally, the lid is a lidding film which is preferably oxygen permeable.

### BRIEF DESCRIPTION OF SEVERAL VIEWS OF THE DRAWINGS

The foregoing summary, as well as the following detailed description of the presently disclosed technology, will be better understood when read in conjunction with the appended drawings, wherein like numerals designate like elements throughout. For the purpose of illustrating the presently disclosed technology, there are shown in the drawings various illustrative embodiments. It should be understood, however, that the presently disclosed technology is not limited to the precise arrangements and instrumentalities shown. In the drawings:

FIG. 1A is a partially exploded isometric view of an optional embodiment of a container that may be used according to an aspect of the disclosed concept.

FIG. 1B is a cross-sectional side elevation view of the container of FIG. 1 with product stored therein.

FIG. 2A is a partially exploded isometric view of an optional embodiment of a container that may be used according to another aspect of the disclosed concept.

FIG. 2B is a cross-sectional side elevation view of the container of FIG. 2 with product stored therein.

FIG. 3A is a partially exploded isometric view of an optional embodiment of a container that may be used according to another aspect of the disclosed concept.

FIG. 3B is a cross-sectional side elevation view of the container of FIG. 3A with product stored therein.

FIG. 4A is a partially exploded isometric view of an optional embodiment of a container that may be used according to another aspect of the disclosed concept.

FIG. 4B is a cross-sectional side elevation view of the container of FIG. 4A with product stored therein.

FIG. 5A is a partially exploded isometric view of an optional embodiment of a container that is a variation of the container of FIGS. 4A and 4B, and that may be used according to another aspect of the disclosed concept.

FIG. 5B is a cross-sectional side elevation view of the container of FIG. 5A with product stored therein.

FIG. 6A is a perspective view of an optional embodiment of a container that may be used according to another aspect of the disclosed concept.

FIG. 6B is a cross-sectional side elevation view of the container of FIG. 6A with product stored therein.

FIG. 7A is a partially exploded isometric view of an optional embodiment of a container that may be used according to another aspect of the disclosed concept.

FIG. 7B is a cross-sectional side elevation view of the container of FIG. 7A with product stored therein.

FIG. 8 is a perspective view of at least a portion of a container according to an embodiment of the presently disclosed technology.

FIG. 9 is a cross-sectional side elevation view of at least a portion of a container according to an embodiment of the presently disclosed technology.

FIG. 10 is a magnified view of the portion of the container of FIG. 9 identified by “A” in FIG. 9, wherein the portion is shown in an initial or receiving state.

FIG. 11 is another magnified view of the portion of the device of FIG. 9 identified by “A” in FIG. 9, wherein the portion is shown in a subsequent or liquid-trapping state.

FIG. 12 is a partially exploded cross-sectional side elevation view of at least a portion of a container according to an embodiment of the presently disclosed technology.

FIG. 13 is a cross-sectional side elevation view of at least a portion of a container according to an embodiment of the presently disclosed technology.

FIG. 14 is a perspective view of a portion of the container shown in FIG. 13.

FIG. 15 is a cross-sectional side elevation view of at least a portion of a container according to an embodiment of the presently disclosed technology.

FIG. 16 is a magnified view of a portion of the container shown in FIG. 15 shown with an absorbent material.

### DETAILED DESCRIPTION

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Unless specifically set forth herein, the terms “a,” “an” and “the” are not limited to one element but instead should be read as meaning “at least one.”

### Definitions

As used in this disclosure, the term “platform” generally refers to a bed or floor atop which product can be placed for storage. The term “platform” may optionally include a single, continuous supporting surface. For example, the platform may include a tabletop-like solid surface, a slanted roof-like solid surface or a convex-shaped solid surface. In another example of a single, continuous supporting surface embodiment of a platform, a substantially flat filter or membrane (such as a non-woven material) may be provided. Alternatively, the platform may optionally include a surface comprising small openings akin to a food strainer, a mesh or a screen. Alternatively, the term “platform” as used herein may refer to a plurality of separate supporting surfaces that cumulatively provide a bed or floor atop which product can be placed for storage, according to an optional aspect of the disclosed concept. In optional embodiments, the platform may include a contacting surface (e.g., of a filter), a filter or membrane and a supporting surface (e.g., upper surface of a rib or mesh screen) directly beneath it. Optionally, the platform is integral with the remainder of the container. Alternatively, the platform is or comprises a separate component that is assembled with or removably disposed within the remainder of the container.

### Optional Embodiments of Container

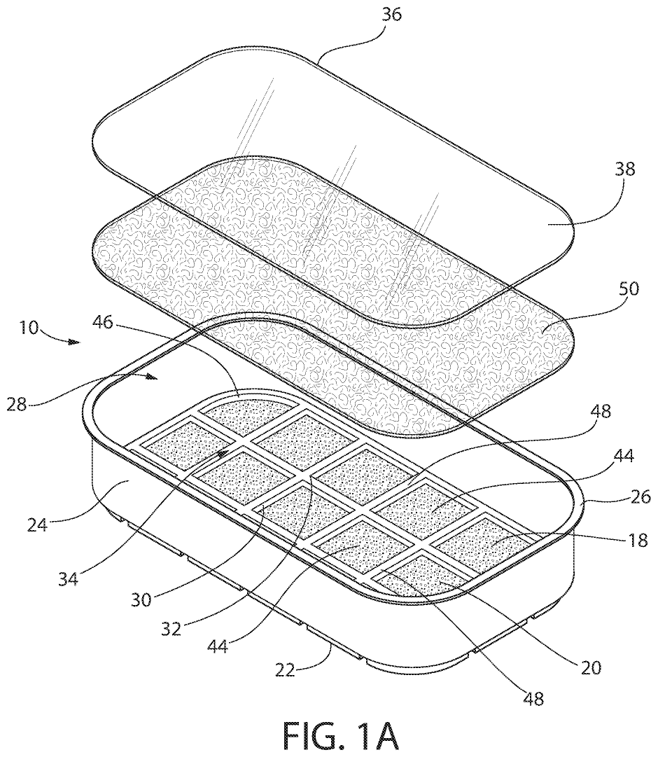

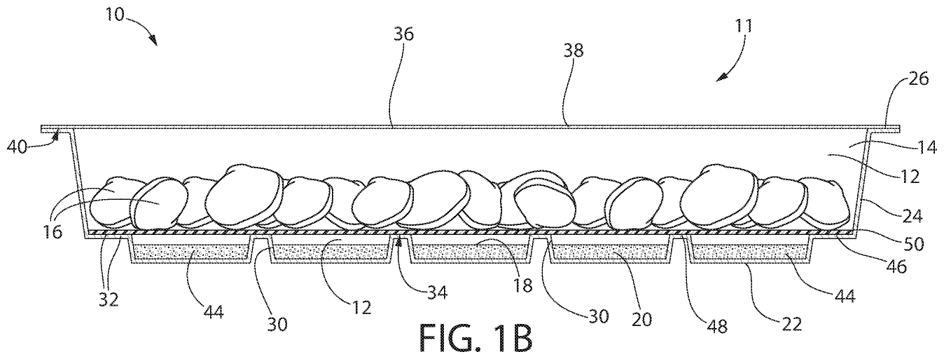

Referring now in detail to the various figures of the drawings wherein like reference numerals refer to like parts, there are shown in FIGS. 1A to 7B various optional embodiments of containers 10, 110, 210, 310, 410, 510, 610 that may be used according to optional aspects of the disclosed concept. To the extent that the various embodiments include elements common to two or more (in some cases, all) container embodiments, such aspects of the embodiments are substantially described herein simultaneously, for brevity. A skilled artisan would readily understand that in appropriate circumstances, various aspects of the different embodiments disclosed herein could be combined and that some aspects or elements could be omitted from or added to a given embodiment.

In one aspect of the disclosed concept, a container 10, 110, 210, 310, 410, 510, 610 is provided. The container 10, 110, 210, 310, 410, 510, 610 can comprise an internal compartment 12, 112, 212, 312, 412, 512, 612 having a product containing space 14, 114, 214, 314, 414, 514, 614 for holding product 16 and a reservoir 18, 118, 218, 318, 418, 518, 618 below the product containing space 14, 114, 214, 314, 414, 514, 614. The reservoir 18, 118, 218, 318, 418, 518, 618 is configured to retain liquid exudate from the product 16.

It is preferred, albeit optional, that an absorbent material 20 is provided within the reservoir 18, 118, 218, 318, 418, 518, 618. In any embodiment, the absorbent material may be in the form of one or more of: absorbent powders, granules, fibers, a sponge, a gel and a coating on a surface within the reservoir, for example. A preferred absorbent material includes solid powder or granules that form a gel upon absorbing liquid. In this manner, when liquid exuded from the product 16 flows or drips into the reservoir 18, 118, 218, 318, 418, 518, 618, the absorbent material 20 absorbs the liquid (e.g., by becoming gelatinous) so as to prevent the liquid from splashing, flowing or leaking from the reservoir 18, 118, 218, 318, 418, 518, 618 back into the product containing space 14, 114, 214, 314, 414, 514, 614. Optional absorbent materials for use in any embodiment of the disclosed concept are further elaborated upon below.

The container 10, 110, 210, 310, 410, 510, 610 optionally comprises a base 22, 122, 222, 322, 422, 522, 622 and a sidewall 24, 124, 224, 324, 424, 524, 624 extending upwardly (e.g., generally or substantially perpendicularly) from the base 22, 122, 222, 322, 422, 522, 622. The base 22, 122, 222, 322, 422, 522, 622 and at least a portion of the sidewall 24, 124, 224, 324, 424, 524, 624 (e.g., a portion directly and continuously extending from the base 22, 122, 222, 322, 422, 522, 622) define the reservoir 18, 118, 218, 318, 418, 518, 618. The reservoir 18, 118, 218, 318, 418, 518, 618 can be fully enclosed along and/or surrounded by the base 22, 122, 222, 322, 422, 522, 622 and along at least a portion of the sidewall 24, 124, 224, 324, 424, 524, 624 extending directly and continuously from the base 22, 122, 222, 322, 422, 522, 622. In this manner, for example, the reservoir 18, 118, 218, 318, 418, 518, 618 is configured to retain liquid, such as liquid exudate from product packaged in the container 10, 110, 210, 310, 410, 510, 610. Accordingly, the reservoir 18, 118, 218, 318, 418, 518, 618 is configured to prevent liquid received therein from leaking outside of the container 10, 110, 210, 310, 410, 510, 610. Optionally, the sidewall 24, 124, 224, 324, 424, 624 terminates at a peripheral edge 26, 126, 226, 326, 426, 626 surrounding a container opening 28, 128, 228, 328, 428, 628 through which product may be deposited into the container 10, 110, 210, 310, 410, 610 or removed therefrom.

The container 10, 110, 210, 310, 410, 510, 610 can further include a support structure 30, 130, 230, 330, 430, 530, 630 disposed in the internal compartment 12, 112, 212, 312, 412, 512, 612. At least a portion of the support structure 30, 130, 230, 330, 430, 530, 630 is rigid or semi rigid, so as to retain its shape under gravity and to support a predetermined amount of product without collapsing under the weight of the same. The support structure 30, 130, 230, 330, 430, 530, 630 can define at least a portion of a platform 32, 132, 232, 332, 432, 532, 632 at an upper end 34, 134, 234, 334, 434, 534, 634 thereof. The platform 32, 132, 232, 332, 432, 532, 632 can be located above the reservoir 18, 118, 218, 318, 418, 518, 618 (e.g., at a height above the height of the reservoir, whether or not the product is at a location axially aligned with the reservoir directly below). In some embodiments, the platform is itself a surface at the upper end of the support structure. In other embodiments, the platform includes the aforementioned surface as well as a cover, layer or membrane placed thereon. The optional cover, as a component of a platform according to some embodiments, is further discussed below.

In any case, the support structure 30, 130, 230, 330, 430, 530, 630 and platform 32, 132, 232, 332, 432, 532, 632 are configured to support the product 16 placed thereon. For example, the support structure 30, 130, 230, 330, 430, 530, 630 may be configured to hold up to 5 pounds (2.27 kg), optionally up to 10 pounds (4.54 kg), optionally up to 15 pounds (6.80 kg), optionally up to 20 pounds (9.07 kg) of product over a period of at least two weeks, without collapsing under the weight of the same. Ultimately, the support structure 30, 130, 230, 330, 430, 530, 630 and the platform 32, 132, 232, 332, 432, 532, 632 are configured to suspend the product 16 above the reservoir 18, 118, 218, 318, 418, 518, 618 so as to separate the product 16 from its exuded juices, which may, via gravity, be directed into the reservoir 18, 118, 218, 318, 418, 518, 618.

The platform 32, 132, 232, 332, 432, 532, 632 and/or the support structure 30, 130, 230, 330, 430, 530, 630 are configured to direct liquid exuded from the product 16 to the reservoir 18, 118, 218, 318, 418, 518, 618. This may be achieved in a variety of ways, exemplary implementations of which are elaborated upon below.

Optionally, the container 10, 110, 210, 310, 410, 510, 610 includes a lid 36, 136, 236, 336, 436, 536, 636 to enclose the product 16 within the container 10, 110, 210, 310, 410, 510, 610. In some optional embodiments (not shown), the lid may include a rigid or semi-rigid removable and replaceable closure means, e.g., a snap on lid. The lid 36, 136, 236, 336, 436, 636 can include a flexible lidding film 38, 138, 238, 338, 438, 638. Examples of a lid 36, 136, 236, 336, 436, 636 including a flexible lidding film 38, 138, 238, 338, 438, 638 are shown covering and enclosing internal compartments 12, 112, 212, 312, 412, 612 of exemplary embodiments of containers 10, 110, 210, 310, 410, 610. As shown in the figures, the lidding film 38, 138, 238, 338, 438, 638 is depicted as having an exaggerated thickness, just so that it is more clearly visible in the figures. In reality, the film's thickness would preferably be less than depicted. For example, the film may be from 0.001 inches to 0.003 inches thick.

Optionally, the lidding film 38, 138, 238, 338, 438, 638 is secured to the peripheral edge 26, 126, 226, 326, 426, 626 of the side wall 24, 124, 224, 324, 424, 624 of the container 10, 110, 210, 310, 410, 610, e.g., by a tie layer. Optionally, the tie layer is a polyethylene tie layer that is optionally co-extruded onto the peripheral edge 26, 126, 226, 326, 426, 626, to bond the lidding film 38, 138, 238, 338, 438, 638 thereto by a heat seal 40, 140, 240, 340, 440, 640. The lid 36, 136, 236, 336, 436, 536, 636 and/or the lidding film 38, 138, 238, 338, 438, 638 can be transparent, translucent or opaque.

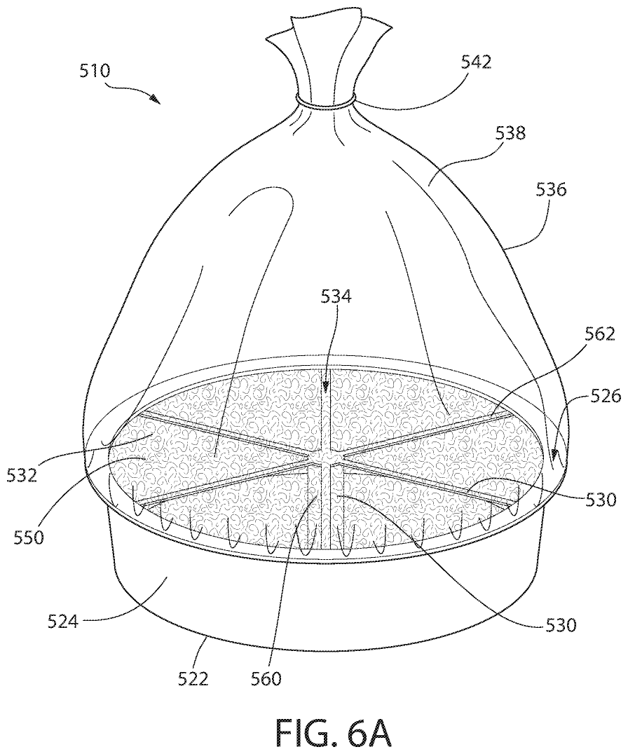

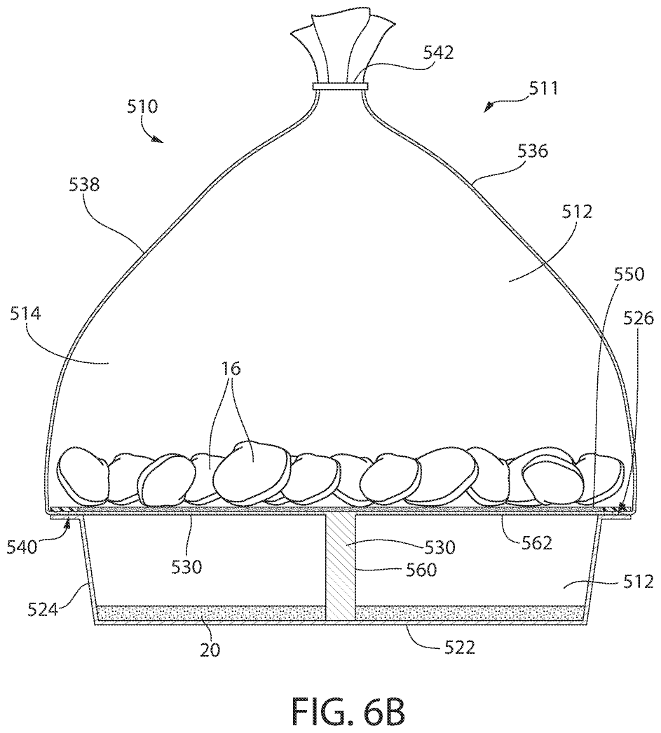

Alternatively, as shown in FIGS. 6A and 6B, the lid 536 may be in the form of a flexible bag or wrap 538 configured to enclose the product 16 within the product containing space 514. The bag or wrap 538 is optionally secured to a peripheral edge 526 of the sidewall 524 of the container 510 (e.g., by a tie layer and heat seal 540, as described above) and may be sealed or crimped closed at a top portion 542 thereof. In an alternative embodiment, the bag or wrap may include a closed bottom into which the tray is placed (such that the bottom of the bag is oriented below the tray), with the bag or wrap sealed or crimped closed at a top portion thereof.

Regardless of the form of the lid, it can be important that the lid provide a desirable oxygen transmission rate for product. Packaging that provides an oxygen transmission rate of 10,000 cc/m²/24 hrs at 24° C., or higher, is regarded as an oxygen-permeable packaging material for product. An oxygen permeable package should provide sufficient exchange of oxygen to allow naturally occurring, aerobic spoilage organisms on the product to grow and spoil the product before toxin is produced under moderate abuse temperatures. Thus, in one optional embodiment, a lidding film 38, 138, 238, 338, 438, 638 or wrap 538 is disposed over the product containing space 14, 114, 214, 314, 414, 514, 614 to enclose the product 16 stored therein so as to provide an oxygen permeable package. Optionally, the container is enclosed with a lidding film that provides an oxygen transmission rate of at least 10,000 cc/m²/24 hrs at standard temperature and pressure (ASTM D3985). Such film is known in the field as a 10K OTR lidding film. Some products benefit from a much lower oxygen transmission rate. For example, in an optional embodiment, a lidding film providing less than 100 cc/m²/24 hrs may be used. Optionally, the lidding film is transparent, which allows a user to view the quality of the seafood stored in the container. In an embodiment, the lidding film is a polyethylene composition, optionally a biaxially stretched polyethylene composition. For example, the lidding film may be the PLASTOFRESH 10K by PLASTOPIL or the 10K OTR Vacuum Skin Package film by CRYOVAC®.

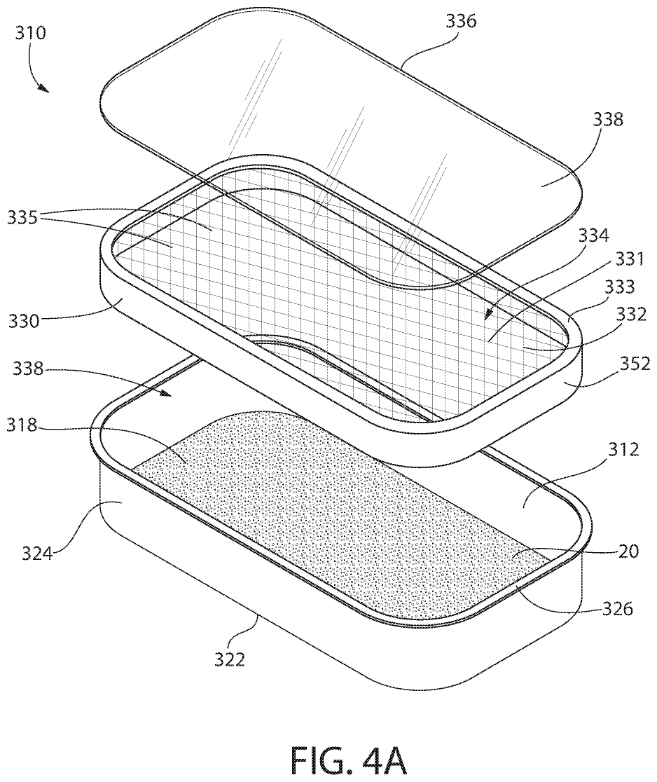

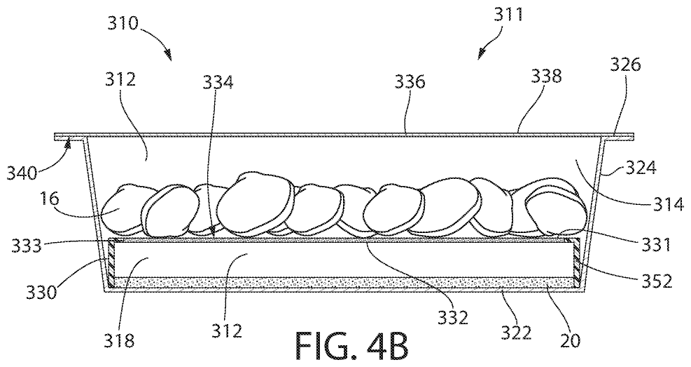

In some optional embodiments (see, e.g., FIGS. 1A-3B, and 5A-5B), the reservoir 18, 118, 218, 418 is divided into separate wells or compartments 44, 144, 244, 444. In other optional embodiments (see, e.g., FIG. 4A-4B), the reservoir 318, comprises a single continuous compartment beneath the platform 332. At least the base 22, 122, 222, 322, 422, 522, 622 and a portion of the sidewall 24, 124, 224, 324, 424, 624 extending therefrom can be formed of a rigid or semi-rigid polymer, optionally polypropylene or polyethylene. For example, at least portions of the reservoir 18, 118, 218, 318, 418, 518, 618 can be configured to have sufficient rigidity to retain the shape of the reservoir under gravity, in contrast, for example, to a bag or pouch that lacks a rigid frame or the like. In any of the embodiments, the container 10, 110, 210, 310, 410, 510, 610 can be disposable. Optionally, at least a portion of the container 10, 110, 210, 310, 410, 510, 610 can include a thermoformed plastic tray (e.g., forming the base 22, 122, 222, 322, 422, 522, 622 and at least a portion of the sidewall 24, 124, 224, 324, 424, 624 extending therefrom).

In an optional aspect of the disclosed concept, a filled and closed package 11, 111, 211, 311, 411, 511, 611 is provided, comprising the assembled container 10, 110, 210, 310, 410, 510, 610 with product 16 stored therein and with the lid 36, 136, 236, 336, 436, 536, 636 enclosing the product 16 within the container 10, 110, 210, 310, 410, 510, 610.

Elements common to two or more container embodiments were described simultaneously above, for brevity. At this point in the disclosure, specific details and features relating to each of the exemplary containers will be elaborated upon or introduced. It should be understood that description of any of the basic or common aspects shared by two or more embodiments will not necessarily be repeated here, since they have already been described above. The following details of the above-described embodiments serve to supplement the disclosure of the various containers 10, 110, 210, 310, 410, 610 set forth above.

FIGS. 1A and 1B show an optional embodiment of a container 10, which is optionally formed from a thermoformed polymer tray (although other materials may be used). The container 10 includes a support structure 30 in the internal compartment 12. In this embodiment, the support structure 30 includes a perimeter rib 46 running along an entire perimeter of the sidewall 24 and a plurality of intersecting ribs 48, each of which extends from the perimeter rib 46, across the base 22 and to an opposite end of the perimeter rib 46. The upper end 34 of the support structure 30 forms a portion of the platform 32. Preferably, the platform 32 also includes a cover 50, optionally made from a filter or membrane, e.g., comprising a non-woven material. The cover 50 in this embodiment thus provides a liquid permeable surface, which is configured to direct liquid exuded from the product 16 into the reservoir 18. As shown, an absorbent material 20 is provided in the wells 44 of the reservoir 18. Alternatively (not shown), the reservoir 18 contains no absorbent material.

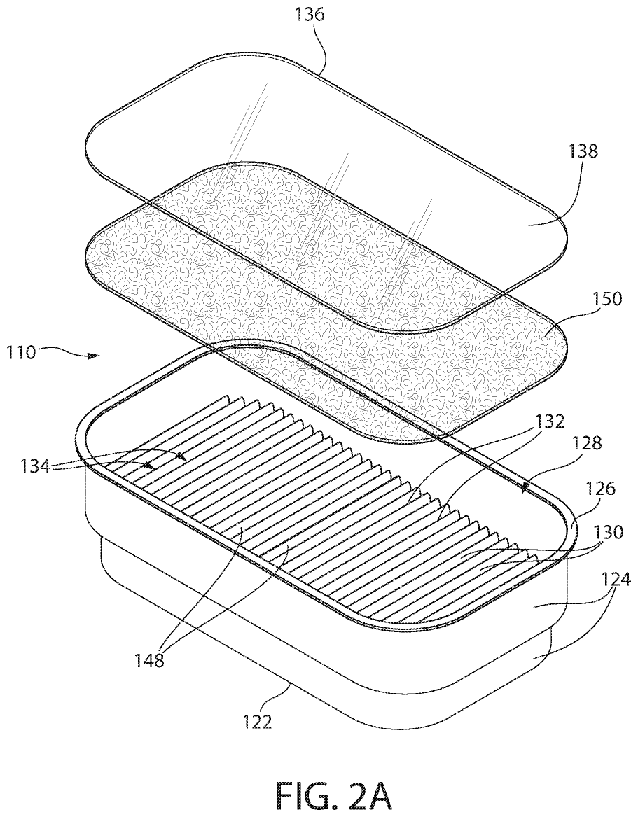

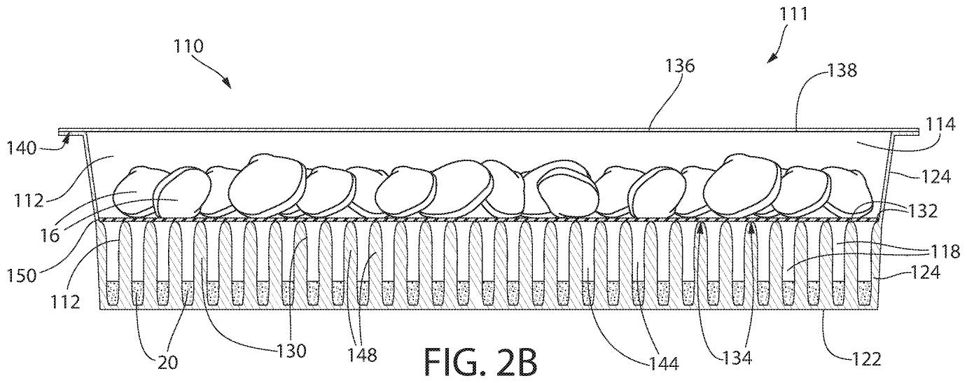

FIGS. 2A and 2B show another optional embodiment of a container 110, which is optionally formed from a thermoformed polymer tray (although other materials may be used). In this embodiment, the support structure 130 is corrugated or undulating, and includes a plurality of spaced ribs 148 extending across the base 122, from one end of the sidewall 124 to the other. The ribs 148 may resemble steep (essentially vertical) rolling hills with deep valleys therebetween. In this embodiment, the “peaks” of the “hills” constitute the upper end 134 of the support structure 130 and the “valleys” provide the wells or compartments 144 of the reservoir 118. The upper end 134 of the support structure 130 forms a portion of the platform 132.

Optionally, the platform 132 also includes (or works in conjunction with) a cover 150, optionally made from a filter or membrane, e.g., comprising a non-woven material. The cover 150 in this embodiment thus provides a liquid permeable surface, which is configured to direct liquid exuded from the product 16 into the reservoir 118. As shown in FIG. 2B, an absorbent material 20 is provided in the wells or compartments 144 of the reservoir 118. Alternatively (not shown), the reservoir 118 contains no absorbent material.

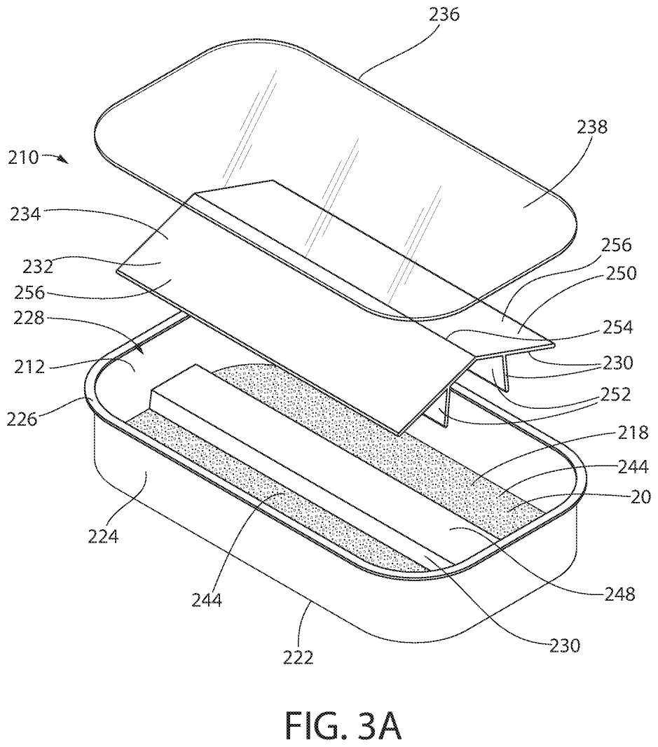

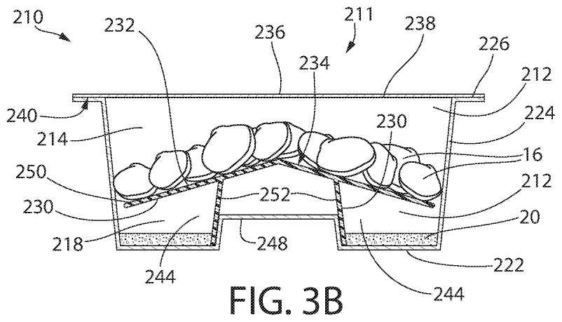

FIGS. 3A and 3B show another optional embodiment of a container 210, which is optionally formed from a thermoformed polymer tray (although other materials may be used). In this embodiment, a central rib or divider 248 extends longitudinally along the base 222 from one end of the sidewall 224 to an opposite end of the sidewall 224.

Optionally, a pair of flanges 252 extend downward from the cover 250 and are together configured to form a press-fit engagement with the rib 248. In this way, the rib 248 and flanges 248 form portions of the support structure 230, the upper end 234 of which forms the platform 232 and cover 250.

In this embodiment, the cover 250 is optionally rigid or semi-rigid and is optionally liquid impermeable (unlike, for example, the covers 50, 150 of FIGS. 1A-2B). The platform 232 can include a central peak 254, wherein the platform 232, on each side of the peak 254, comprises a downwardly inclined ramp 256 providing for liquid runoff from a side of the platform 232. Optionally (not shown), the platform comprises a convex sectional profile. The support structure 230 and/or the platform 232 are thus configured to direct liquid exuded from the product 16 into the reservoir 218. As shown, an absorbent material 20 is provided in the wells or compartments 244 (on either side of the rib 248) of the reservoir 218. Alternatively (not shown), the reservoir 218 contains no absorbent material.

FIGS. 4A and 4B show another optional embodiment of a container 310, which is optionally formed from a thermoformed polymer tray (although other materials may be used). In this embodiment, the reservoir 318 is optionally not subdivided into individual distinct compartments or wells, but is rather provided as one single compartment occupying essentially the entire footprint of the base 322. The platform 332 optionally includes a mesh material 331 that is retained in place by a frame 333 of the support structure 330.

The support structure 330 further can include a flange 352, optionally projecting downwardly from and about the perimeter of the frame 333. The flange 352 of the support structure 330 thus operates to suspend the platform 332 above the reservoir 318. In this way, the platform 332 provides a plurality of openings 335 configured to direct liquid exuded from the product 16 into the reservoir 318. Optionally (not shown), the platform 332 further includes a liquid permeable cover (such as 50), e.g., disposed atop the mesh material 331. As shown, an absorbent material 20 is provided in the reservoir 318. Alternatively (not shown), the reservoir 318 contains no absorbent material.

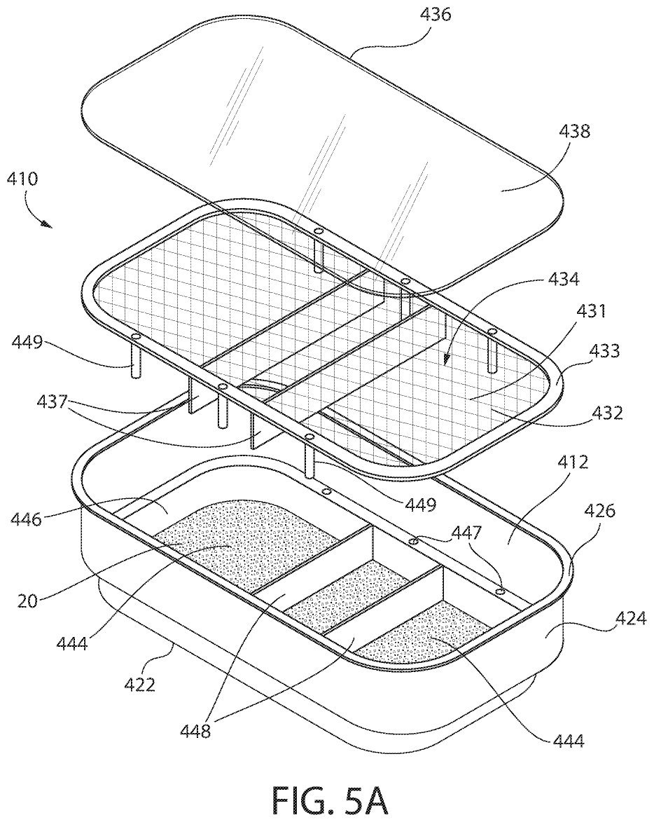

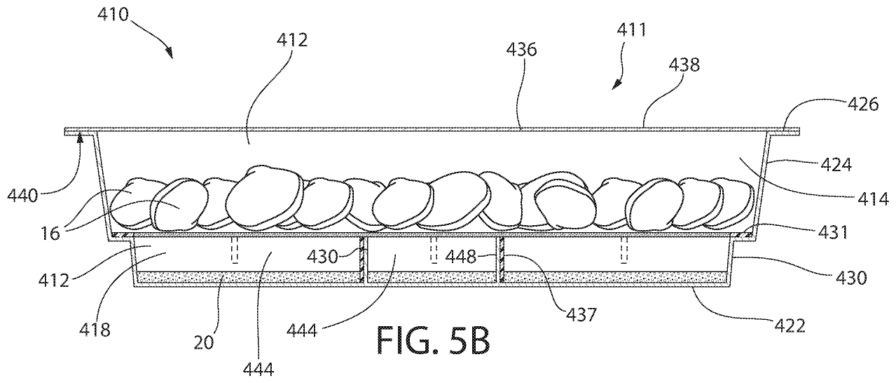

FIGS. 5A and 5B show another optional embodiment of a container 410, which is optionally formed from a thermoformed polymer tray (although other materials may be used). The platform 432 optionally includes a mesh material 431 that is retained in place by a frame 433 of the support structure 430. The upper end 434 of the support structure 430 forms a portion of the platform 432.

The support structure 430 can further include a perimeter rib 446 running along an entire inner perimeter of the sidewall 424. In addition, the support structure 430 optionally includes two ribs 448 spanning the width of the base 422 from one side of the perimeter rib to the other and optionally two flanges 437 projecting downwardly from the platform 432 and spanning the width thereof. The support structure 430 is configured such that each flange 437 engages and/or contacts a corresponding rib 448 to stabilize the platform 432 within the internal compartment 412 and/or prevent significant movement of the platform 432.

Optionally, the perimeter rib 446 includes a plurality of holes 447 and the frame 433 includes a plurality of corresponding pins 449 that care sized, shaped and/or configured to be aligned with and inserted into the holes 447. This optional feature further helps to retain and stabilize the platform 432.

The support structure 430 thus operates to suspend the platform 432 above the reservoir 418. In this way, the platform 432 provides openings 435 configured to direct liquid exuded from the product 16 into the reservoir 418. Optionally (not shown), the platform 432 further includes a liquid permeable cover (such as 50), e.g., disposed atop the mesh material 431. As shown, an absorbent material 20 is provided in the reservoir 418. Alternatively (not shown), the reservoir 418 contains no absorbent material.

FIGS. 6A and 6B show another optional embodiment of a container 510, which is optionally formed from a thermoformed polymer tray (although other materials may be used). In this embodiment, the tray is round, however it should be understood that the tray may be provided in alternative shapes, e.g., rectangular, square or oval, for example.

As with the other embodiments disclosed herein, the container 510 includes a support structure 530 in the internal compartment 512. The support structure 530 can include a central pillar 560 from which a plurality of evenly spaced support beams 562 extend radially to the sidewall 524. The upper end 534 of the support structure 530 forms a portion of the platform 532. Preferably, the platform 532 also includes a cover 550, optionally made from a filter or membrane, e.g., comprising a non-woven material. The cover 550 in this embodiment thus provides a liquid permeable surface, which is configured to direct liquid exuded from the product 16 into the reservoir 518. As shown, an absorbent material 20 is provided in the reservoir 518. Alternatively (not shown), the reservoir 518 contains no absorbent material.

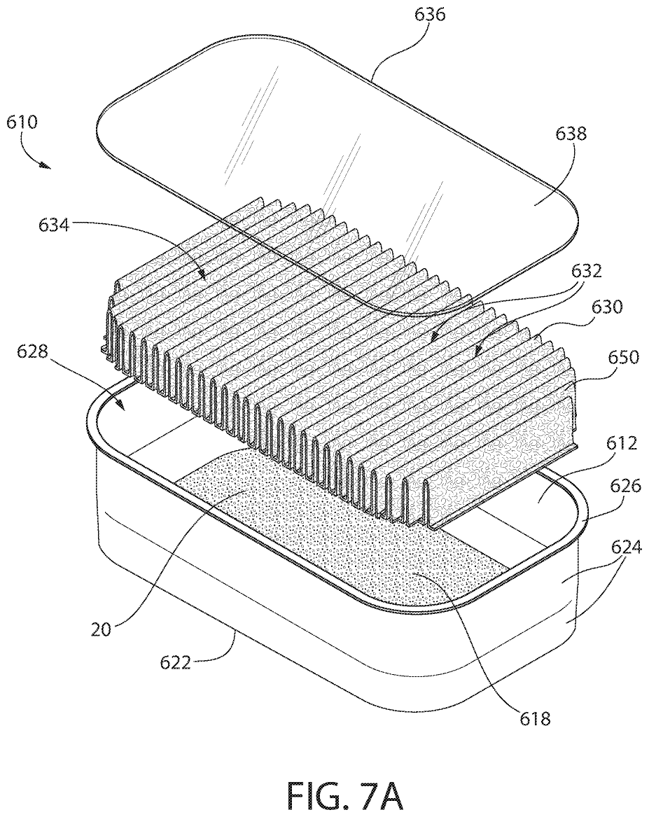

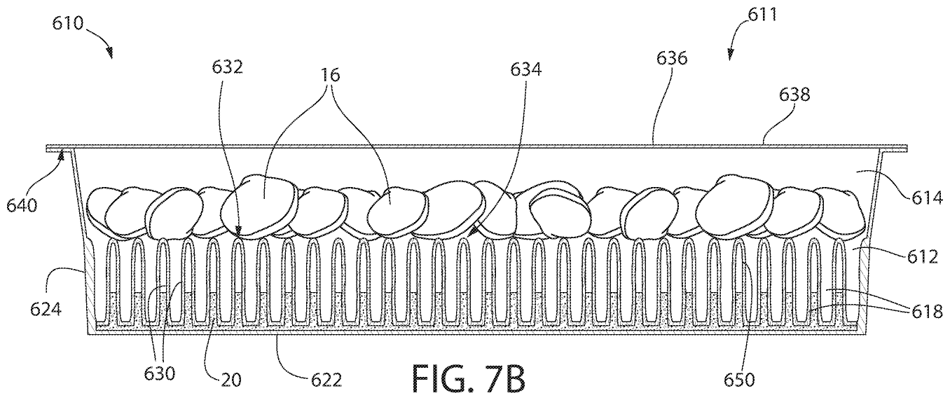

FIGS. 7A and 7B show another optional embodiment of a container 610, which is optionally formed from a thermoformed polymer tray (although other materials may be used). As with the other embodiments disclosed herein, the container 610 includes a support structure 630 in the internal compartment 612. The support structure 630 in this embodiment can include a corrugated rigid cover 650. The cover 650 may be made from, for example, a non-woven material that is liquid permeable and rigid. The rigidity of the material may be provided using a stiffening finish. Alternatively (or in addition), the rigidity of the material may be provided by increasing its thickness and molding or pleating it into the corrugated shape.

Uniquely, in this embodiment, the cover 650 itself serves as support structure 630 and itself provides the upper end 634 of the support structure 630, forming the platform 632. It should be understood that the support structure may be provided in shapes and configurations other than corrugated, so long as the support structure is sufficiently rigid to function simultaneously as a cover and a platform. The cover 650 and the platform 632 in this embodiment thus provide a liquid permeable surface, which is configured to direct liquid exuded from the product 16 into the reservoir 518. Preferably, a bed of absorbent material 20 is provided in the reservoir 618. Optionally, some of the absorbent material 20 is disposed within the “hills” (e.g., see description above in earlier embodiment) of the corrugated cover 650. Alternatively (not shown), the reservoir 618 contains no absorbent material.

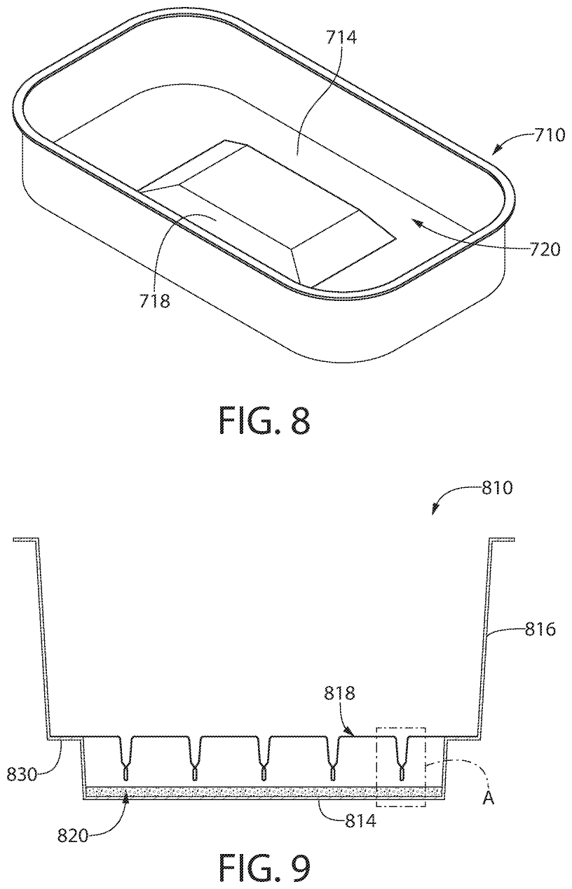

FIG. 8 shows another embodiment of the presently disclosed technology. FIG. 8 provides for a container 710 of the present embodiment including a support structure 718 extending upwardly from the bottom wall 714 of the container 710. The support structure 718 can be integrally formed with the bottom wall 714, or can be separable from the bottom wall 714. Thus, the container 710 can be of one-piece or two-piece construction. The support structure 718 can include a flat or generally flat top surface that serves as a support surface for supporting and/or directly contacting the liquid-exuding product (not shown). One or more side walls of the support structure 718 can be slanted or sloped, which can function to move or direct any liquid exuded from the liquid-exuding product away from the liquid-exuding product in a gradual manner. The space surrounding the support structure 718 can be a reservoir 720 designed to receive and/or hold any liquid exuded from the liquid-exuding product. Thus, in one embodiment, the entire support structure 718 is spaced inwardly from the side wall 716 of the container 710.

Optionally, the reservoir 720 can include or contain an absorbent material (not shown). Optionally, a filter, membrane or separator can be placed on the support surface of the support structure 718 and can separate the support surface from the liquid-exuding product. In one embodiment, at least a portion of or the entire outer periphery of the support surface can include a fence-like feature that extends upwardly therefrom to contain the liquid-exuding product on the support structure 718.

FIGS. 9-11 show another embodiment of the presently disclosed technology. Similar or identical structure as between the embodiment of FIG. 8 and FIGS. 9-11 is distinguished in FIGS. 9-11 by a reference number with a magnitude eight hundred (800). Description of certain similarities between the earlier embodiments and the embodiment of FIGS. 9-11 may be omitted herein for convenience and brevity only.

In the present embodiment, a support structure 818 can, optionally, be removably placed within the container 810 proximate the bottom wall 814 thereof. In one embodiment, the support structure 818 can be sized, shaped and/or configured to form a tight or snap-fit with an interior surface of a side wall 816 of the container 810. Optionally, an outer periphery of the support structure 818 can contact or rest on a top surface of a ledge 830 on the interior surface of the side wall 816 of the container 810.

Optionally, in one embodiment, the outer periphery of the support structure 818 is heat sealed to the container 810 and/or the ledge 830. A reservoir 820 can be located beneath the support structure 318. Absorbent material can be located in the reservoir 820, or the reservoir 820 can function without absorbent material.

Referring to each of FIGS. 9-11, the support structure 818 can include one or a plurality of drainage tubes or receptacles 832. Each tube 832 can have an open upper end and a lower closed end. The tubes 832 can be arranged in a predetermined pattern, such as one or more rows and/or column. Each tube 832 can be relatively thin and optionally formed with a vacuum.

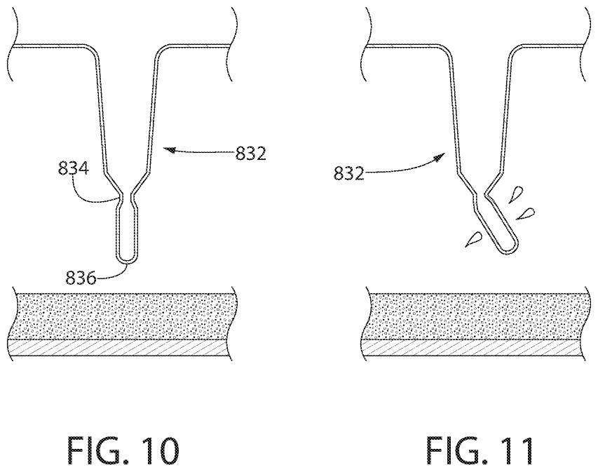

As shown in FIG. 10, a mid-portion of each tube 832 can be crimped or narrowed 834 and cut or opened at a bottom portion thereof 836. During use, as shown in FIG. 11, each tube 832 can buckle, bend, or seal when a predetermined amount of liquid or moisture passes therethrough, thereby trapping liquid or moisture (or at least making it more difficult to escape) that travels to the reservoir 820 to return to the area or space that includes the liquid-exuding product.

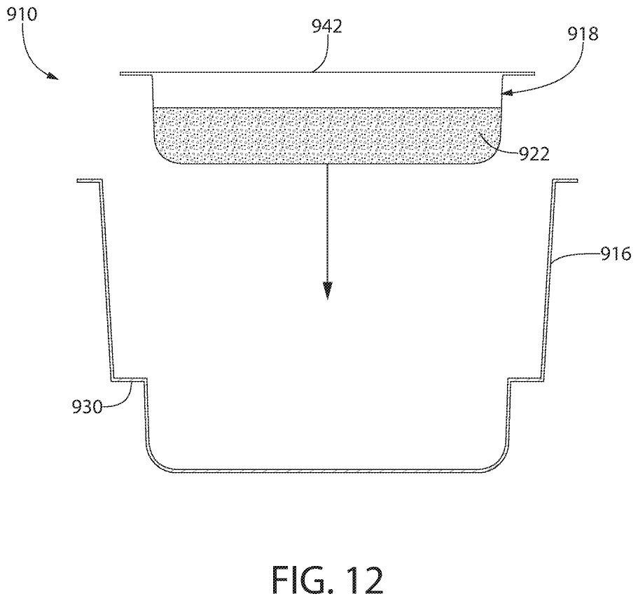

FIG. 12 shows another embodiment of the presently disclosed technology. Similar or identical structure as between the embodiments of FIGS. 8-11 and FIG. 12 is distinguished in FIG. 12 by a reference number with a magnitude nine hundred (900). Description of certain similarities between the earlier embodiments and the embodiment of FIG. 12 may be omitted herein for convenience and brevity only.

The container 910 of the present embodiment can include or receive a support structure 918. Optionally, the support structure 918 can have a permeable filter or membrane 942 as a top surface. Further, the membrane 932 can enclose an absorbent material 922 within a body of the support structure 918. However, as with other embodiments described above, an absorbent material 922 is not required to be in the support structure 918.

An outer periphery of the support structure 918 can contact, rest on and/or be attached to a ledge 930 formed on an inner surface of a side wall of the container 918. Optionally, at least a portion of the support structure 918 can be fixedly attached to the container 910 (e.g., to an interior surface of the bottom wall 914 and/or the side wall 916), such as by heat sealing or ultrasonic weld.

Such an embodiment allows the container 910 and the support structure 918 to be stored and/or shipped separately and combined only when and/or if desired. Further, in an embodiment where the support structure 918 is not permanently secured to the container 910, the support structure 918 can be discarded after a single use, but the container 910 could be reused, if desired.

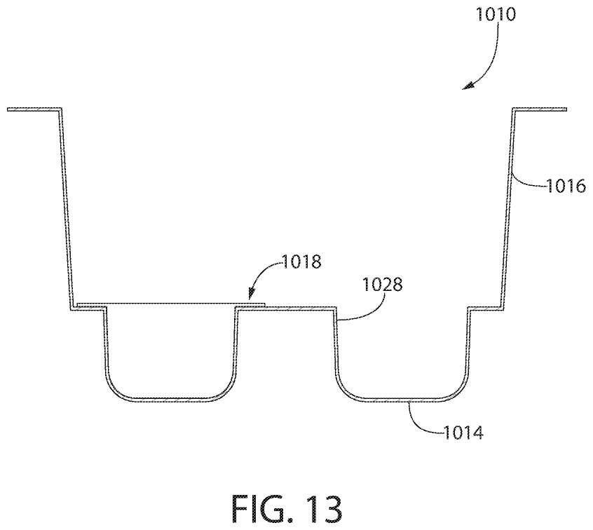

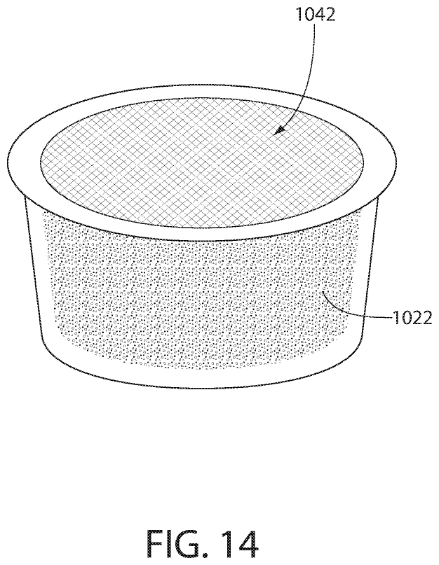

FIGS. 13-14 show another embodiment of the presently disclosed technology. Similar or identical structure as between the embodiments of FIGS. 8-12 and FIGS. 13-14 is distinguished in FIGS. 13-14 by a reference number with a magnitude one thousand (1000). Description of certain similarities between the earlier embodiments and the embodiment of FIGS. 13-14 may be omitted herein for convenience and brevity only.

The container 1010 of the present embodiment is substantially similar to that shown and described with respect to FIG. 14. However, two or more support structures 1018 can be removably or permanently placed within the container 1010. In one embodiment, each support structure 1018, when placed within the container 1010, case be separated by a projection, ridge or rib 1028 extending upwardly from the bottom wall 1014 of the container 1010.

Optionally, each support structure 1018 can be secured to at least a portion of the container, such as a bottom wall 1014 or a side wall 1016 thereof. Furthermore, as shown in FIG. 14, each support structure 1018 optionally includes a permeable filter or membrane 1042 as a top surface and enclosing an absorbent material 1022 within a body of the support structure 1018. Alternatively, in at least certain situations the support structure 1018 can function satisfactorily without absorbent material contained therein.

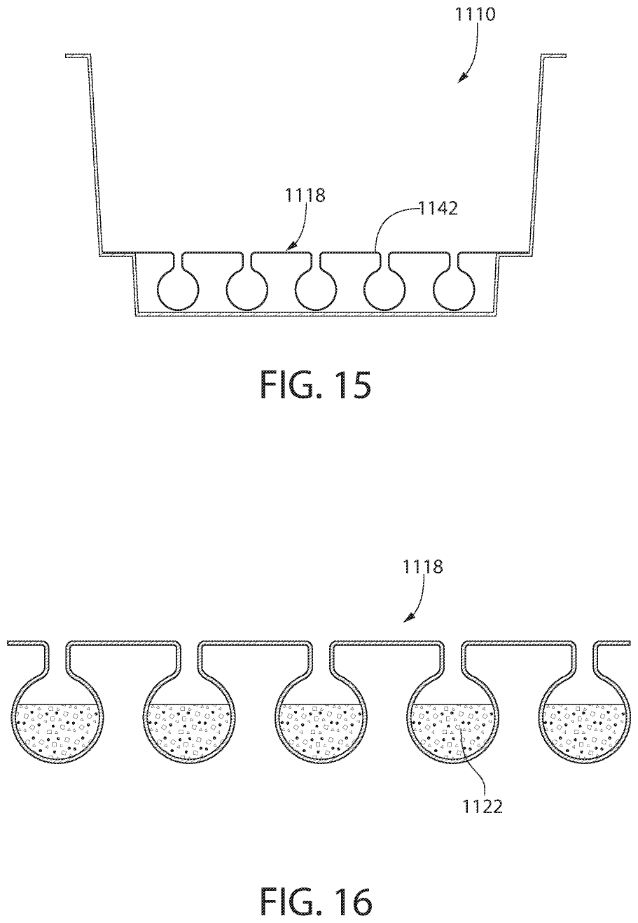

FIGS. 15-16 show another embodiment of the presently disclosed technology. Similar or identical structure as between the embodiments of FIGS. 8-14 and FIGS. 15-16 is distinguished in FIGS. 15-16 by a reference number with a magnitude one thousand one hundred (1100). Description of certain similarities between the earlier embodiments and the embodiment of FIGS. 15-16 may be omitted herein for convenience and brevity only.

The container 1110 of the present embodiment includes a support structure 1118 that includes one or a plurality of spaced-apart pleats. Optionally, the support structure 1118 includes a plurality of spaced-apart one-inch pleats. Stated differently, the support structure 1118 includes a plurality of tear drop-shaped compartments or cavities designed or configured to receive liquid from the liquid-exuding product.

In one embodiment, the support structure 1118 is formed of a membrane 1142 that is woven or non-woven. In another embodiment, the support structure 1118 is formed of a non-porous material, such as a polymeric material. Each pleat forms a gap or passageway through which liquid or moisture can flow from the liquid-exuding product and a cavity to receive and/or hold liquid or moisture from the liquid-exuding product. Thus, in one embodiment, each pleat is in the shape of a balloon or light bulb. In combination, the cavities form a reservoir 1120. Optionally, each cavity can contain an absorbent material 1122, though absorbent material is not required.

Alternatively (not shown), a container is provided which includes a plurality of individual product containing spaces for storing product. Aside from the fact that this alternative container is divided into separate product containing spaces, any of the disclosed concepts discussed herein may be utilized to carry out this alternative embodiment. Each individual product containing space may include a lidding film enclosing the product in the given space. In this way, if a lidding film is removed from one product containing space, the other compartments remain sealed so that the unused product stored in them may be put away again for refrigerated storage, for example.

### Optional Liquid Permeable Cover Material

As discussed above with respect to embodiments of a liquid permeable cover 50, 150, 550, 650, the cover (and platform of which it can be a part or of which it can form) provides a liquid permeable surface. Such a surface is configured to direct liquid exuded from the product into the reservoir. The cover may be made from any liquid permeable material that has sufficient durability to withstand wet conditions for at least a couple weeks.

Optionally, in any embodiment, the cover comprises a spunbond synthetic nonwoven material. If a spunbond synthetic nonwoven material is used for the cover, a preferred brand is the AHLSTROM WL257680. Preferably, the material is food contact safe and is compliant with U.S. Federal Food and Drug Administration regulations 21 C.F.R. §§ 177.1630 and 177.1520.

Optionally, in any embodiment, the cover material facilitates unidirectional movement of liquid therethrough, such that the liquid permeates downward from the product containing space into the reservoir, but not vice versa. In other words, the cover material is optionally a one-way material. Optionally, such one-way material may include TREDEGAR brand plastic films.

Optionally, in any embodiment, the cover is from 50 microns to 500 microns thick, optionally, 250 microns (48 GSM) or 130 microns (20 GSM).

Optionally, in any embodiment, the cover has a porosity of from 200 L/min/m² to 2,000 L/min/m², optionally 620 L/min/m².

Optionally, where the cover lays atop a support structure (e.g., ribs, 46, 48), the cover (e.g., 50) is heat sealed to the upper end (e.g., 34) thereof.

Optionally, cover materials other than nonwovens may include a scrim, for example.

Optionally, in some embodiments, it may be desirable to make the cover stiff or rigid. In the case of nonwovens, this may be done using a stiffening finish. Alternatively (or in addition), the rigidity of the material may be provided by increasing its thickness and molding or pleating it into a desired shape. The final material would be rigid or semi rigid. For example, the nonwoven material may be configured to have a mass per unit area of 20 g/m² to 100 g/m². Optionally, such material is molded or pleated. Alternatively, such material may be fabricated on a mat that produces the desired shape when a vacuum is applied or forced air is provided through the mat.

Optionally, in any embodiment, the cover has antimicrobial properties. This may be achieved by treating the nonwoven with an antimicrobial finish, comprising, e.g., silver ions or nanoparticles of chlorine dioxide, for example. Alternatively, the antimicrobial elements can be engrained in the material of the nonwoven itself.

### Optional Absorbent Material Composition

In at least certain embodiments it is preferred, although still optional, that an absorbent material 20 is provided within the reservoir 18, 118, 218, 318, 418, 518, 618. As discussed below, the absorbent material 20 may be a composition of matter (e.g., powder mixture) or a single article (e.g., sponge), for example.

Absorbent materials usable in conjunction with methods according to the disclosed concepts include food safe absorbent materials having an absorbent composition of matter suitable for use with food products. The absorbent composition of matter has an absorbency, the absorbency being defined by weight of liquid absorbed/weight of the absorbent composition of matter.

The absorbent material is not particularly limited to any material class. However, the absorbent material needs to be food safe, possesses a desirable absorbency, and exhibits a minimum syneresis. For example, the absorbent material may include one or more of the following: tissue paper, cotton, sponge, fluff pulp, polysaccharide, polyacrylate, psillium fiber, guar gum, locust bean gum, gellan gum, alginic acid, xyloglucan, pectin, chitosan, poly(DL-lactic acid), poly(DL-lactide-co-glycolide), poly-caprolactone, polyacrylamide copolymer, ethylene maleic anhydride copolymer, cross-linked carboxymethylcellulose, polyvinyl alcohol copolymers, cross-linked polyethylene oxide, starch grafted copolymer of polyacrylonitrile, and a cross-linked or non-cross-linked gel-forming polymer.

In at least one embodiment, the absorbent material includes or is formed of a cross-linked or a non-cross-linked gel-forming polymer. Such gel-forming polymer may be water-soluble or insoluble. In another embodiment, the absorbent material further includes at least one of the following: 1) at least one mineral composition, 2) at least one soluble salt having at least one trivalent cation, and 3) an inorganic buffer.

In an optional embodiment, the absorbent material includes at least one non-crosslinked gel-forming water-soluble polymer having a first absorbency, the first absorbency being defined by weight of liquid absorbed/weight of the at least one non-crosslinked gel forming polymer, the at least one non-crosslinked gel forming polymer being safe for products, the absorbent composition of matter being compatible with products such that the absorbent composition of matter is safe when in direct contact with the products.

In an optional embodiment, the absorbent material includes the following: (i) at least one non-crosslinked gel-forming water-soluble polymer having a first absorbency, the first absorbency being defined by weight of liquid absorbed/weight of the at least one non-crosslinked gel forming polymer, the at least one non-crosslinked gel forming polymer being safe for products; and (ii) at least one mineral composition having a second absorbency, the second absorbency being defined by weight of liquid absorbed/weight of the at least one mineral composition, the at least one mineral composition being safe for products, the absorbency of the absorbent material exceeding the first absorbency and the second absorbency, the absorbent material being compatible with products such that the absorbent composition of matter is safe for products when in direct contact with the products. It should, however, be understood that alternative absorbent materials such as those described above may be used in accordance with the disclosed concept.

In an optional embodiment, the absorbent material includes the following: (i) at least one non-crosslinked gel-forming water-soluble polymer having a first absorbency, the first absorbency being defined by weight of liquid absorbed/weight of the at least one non-crosslinked gel forming polymer, the at least one non-crosslinked gel forming polymer being safe for products; and (ii) at least one soluble salt having at least one trivalent cation, the at least one soluble salt having at least one trivalent cation being safe for products, the absorbency of the absorbent material exceeding the first absorbency and the second absorbency, the absorbent material being compatible with products such that the absorbent composition of matter is safe for products when in direct contact with the products. It should, however, be understood that alternative absorbent materials such as those described above may be used in accordance with the disclosed concept.

In an optional embodiment, the absorbent material includes the following: (i) at least one non-crosslinked gel-forming water-soluble polymer having a first absorbency, the first absorbency being defined by weight of liquid absorbed/weight of the at least one non-crosslinked gel forming polymer, the at least one non-crosslinked gel forming polymer being safe for products; (ii) at least one mineral composition having a second absorbency, the second absorbency being defined by weight of liquid absorbed/weight of the at least one mineral composition, the at least one mineral composition being safe for products; and (iii) at least one soluble salt having at least one trivalent cation, the at least one soluble salt having at least one trivalent cation being safe for products, the absorbency of the absorbent composition of matter exceeding a sum of the first absorbency and the second absorbency, the absorbent material being compatible with products such that the absorbent composition of matter is safe for products when in direct contact with the products. It should, however, be understood that alternative absorbent materials such as those described above may be used in accordance with the disclosed concept. Any of the embodiments of the absorbent composition of matter described above may optionally comprise an inorganic or organic buffer.

Optionally, the absorbent material contains from about 10 to 90% by weight, preferably from about 50 to about 80% by weight, and most preferably from about 70 to 75% by weight polymer. The non-crosslinked gel forming polymer can be a cellulose derivative such as carboxymethylcellulose (CMC) and salts thereof, hydroxyethylcellulose, methylcellulose, hydroxypropylmethylcellulose, gelatinized starches, gelatin, dextrose, and other similar components, and may be a mixture of the above. Certain types and grades of CMC are approved for use with food items and are preferred when the absorbent is to be so used. The preferred polymer is a CMC, most preferably sodium salt of CMC having a degree of substitution of about 0.7 to 0.9. The degree of substitution refers to the proportion of hydroxyl groups in the cellulose molecule that have their hydrogen substituted by a carboxymethyl group. The viscosity of a 1% solution of CMC at 25° C., read on a Brookfield viscometer, should be in the range of about 2500 to 12,000 mPa. The CMC used in the Examples following was obtained from Hercules, Inc. of Wilmington, Del. (under the trade name B315) or from AKZO Nobel of Stratford, Conn. (under the trade name AF3085).

The clay ingredient can be any of a variety of materials and is preferably attapulgite, montmorillonite (including bentonite clays such as hectorite), sericite, kaolin, diatomaceous earth, silica, and other similar materials, and mixtures thereof. Preferably, bentonite is used. Bentonite is a type of montmorillonite and is principally a colloidal hydrated aluminum silicate and contains varying quantities of iron, alkali, and alkaline earths. The preferred type of bentonite is hectorite which is mined from specific areas, principally in Nevada. Bentonite used in the Examples following was obtained from American Colloid Company of Arlington Heights, Ill. under the tradename BENTONITE AE-H.

Diatomaceous earth is formed from the fossilized remains of diatoms, which are structured somewhat like honeycomb or sponge. Diatomaceous earth absorbs fluids without swelling by accumulating the fluids in the interstices of the structure. Diatomaceous earth was obtained from American Colloid Company.

The clay and diatomaceous earth are present in an amount from about 10-90% by weight, preferably about 20-30% by weight, however, some applications, such as when the absorbent material is to be used to absorb solutions having a high alkalinity, i.e. marinades for poultry, can incorporate up to about 50% diatomaceous earth. The diatomaceous earth can replace nearly all of the clay, with up to about 2% by weight remaining clay.

The trivalent cation is preferably provided in a soluble salt such as derived from aluminum sulfate, potassium aluminum sulfate, and other soluble salts of metal ions such as aluminum, chromium, and the like. Preferably, the trivalent cation is present at about 1 to 20%, most preferably at about 1 to 8%.

The inorganic buffer is one such as sodium carbonate (soda ash), sodium hexametaphosphate, sodium tripolyphosphate, and other similar materials. The organic buffer may be citric acid, monopotassium phosphate, or buffer mixture with a set pH range. If a buffer is used, it is present preferably at about 0.6%, however beneficial results have been achieved with amounts up to about 15% by weight.

The mixture of the non-crosslinked gel forming polymer, trivalent cation, and clay forms an absorbent material which when hydrated has an improved gel strength over the non-crosslinked gel forming polymer alone. Further, the gel exhibits minimal syneresis, which is exudation of the liquid component of a gel.

In addition, the combined ingredients form an absorbent material which has an absorbent capacity which exceeds the total absorbent capacity of the ingredients individually. While not limited by this theory, it appears that the trivalent cation provides a cross-linking effect on the CMC once in solution, and that the clay swells to absorb and stabilize the gels. Further, as shown by Example D of Table 1 below, it appears that, in some cases at least, it is not necessary to add trivalent cation. It is thought that perhaps a sufficient amount of trivalent cation is present in the bentonite and diatomaceous earth to provide the crosslinking effect.

The gels formed by the absorbent material of the presently disclosed technology are glass clear, firm gels which may have applications in other areas such as for cosmetic materials.

The ingredients for the composition are optionally mixed together and then formed into granules. It has been found that at least some embodiments of the presently disclosed technology may be agglomerated by processing without addition of chemicals in a compactor or disk type granulator or similar device to produce granules of uniform and controllable particle size. Granules so formed act as an absorbent with increased rate and capacity of absorption due to the increased surface area of the absorbent. The preferred granule size is from about 75 to 1,000 microns, more preferably from about 150 to 800 microns, and most preferably from about 250 to 600 microns, with the optimum size depending upon the application. Water or another binding agent may be applied to the blend while it is being agitated in the compactor or disk type granulator which may improve the uniformity of particle size. Further, this method is a way in which other ingredients can be included in the composition, such as surfactants, deodorants and antimicrobial agents.

Optionally, one or more odor absorbers may be included in the absorbent material. Examples of such odor absorbers include: zinc chloride optionally in an amount of from greater than 0.0 to 20.0% by weight, zinc oxide optionally in an amount of from greater than 0.0 to 20.0% by weight and citric acid optionally in an amount of from greater than 0.0 to 50.0% by weight. Where the absorbent material comprises from 30% to 80% non-crosslinked gel-forming polymer, optionally carboxymethylcellulose, the amount of the absorbent material is adjusted according to the amount of odor absorber included in the absorbent material.

Optionally, at least one antimicrobial agent is included or blended with the absorbent material. For example, the at least one antimicrobial agent includes compositions described in U.S. Pat. No. 7,863,350, incorporated by reference herein in its entirety. The term “antimicrobial agent” is defined herein as any compound that inhibits or prevents the growth of microbes within the container. The term “microbe” is defined herein as a bacterium, fungus, or virus. The antimicrobial agents useful herein include volatile antimicrobial agents and non-volatile antimicrobial agents. Combinations of the volatile and non-volatile antimicrobial agents are also contemplated.

The term “volatile antimicrobial agent” includes any compound that when it comes into contact with a fluid (e.g., liquid exuded from a product), produces a vapor of antimicrobial agent. In one aspect, the volatile antimicrobial agent is from 0.25 to 20%, 0.25 to 10%, or 0.25 to 5% by weight of the absorbent material. Examples of volatile antimicrobial agents include, but are not limited to, origanum, basil, cinnamaldehyde, chlorine dioxide, vanillin, cilantro oil, clove oil, horseradish oil, mint oil, rosemary, sage, thyme, wasabi or an extract thereof, a bamboo extract, an extract from grapefruit seed, an extract of Rheum palmatum, an extract of coptis chinesis, lavender oil, lemon oil, eucalyptus oil, peppermint oil, Cananga odorata, Cupressus sempervirens, Curcuma longa, cymbopogon citratus, eucalyptus globulus, pinus radiate, piper crassinervium, psidium guayava, Rosmarinus officinalis, Zingiber officinale, thyme, thymol, allyl isothiocyanate (AIT), hinokitiol, carvacrol, eugenol, α-terpinol, sesame oil, or any combination thereof.

Depending upon the application, the volatile antimicrobial agent can be used alone or in combination with solvents or other components. In general, the release of the volatile antimicrobial agent can be varied by the presence of these solvents or components. For example, one or more food safe solvents such as ethanol or sulfur dioxide can be mixed with the volatile antimicrobial agent prior to admixing with the absorbent composition. Alternatively, the volatile antimicrobial agent can be coated with one or more water-soluble materials. Examples of such water-soluble material include cyclodextrin, maltodextrin, corn syrup solid, gum arabic, starch, or any combination thereof. The materials and techniques disclosed in U.S. Published Application No. 2006/0188464 can be used herein to produce the coated volatile antimicrobial agents.

In other aspects, non-volatile antimicrobial agents may be used in combination with or as an alternative to volatile antimicrobial agents. The term “non-volatile antimicrobial agent” includes any compound that when it comes into contact with a fluid (e.g., liquid exuded from a product), produces minimal to no vapor of antimicrobial agent. In one aspect, the volatile antimicrobial agent is from 0.5 to 15%, 0.5 to 8%, or 0.5 to 5% by weight of the food preservation composition. Examples of non-volatile antimicrobial agents include, but are not limited to, ascorbic acid, a sorbate salt, sorbic acid, citric acid, a citrate salt, lactic acid, a lactate salt, benzoic acid, a benzoate salt, a bicarbonate salt, a chelating compound, an alum salt, nisin, or any combination thereof. The salts include the sodium, potassium, calcium, or magnesium salts of any of the compounds listed above. Specific examples include calcium sorbate, calcium ascorbate, potassium bisulfite, potassium metabisulfite, potassium sorbate, or sodium sorbate.

### Optional Use of Antimicrobial Gas Releasing Agents

Optionally, in any embodiment of the disclosed concept, methods and articles for inhibiting or preventing the growth of microbes and/or for killing microbes in a closed package may be utilized. Such methods and articles are described in PCT/US2017/061389, which is incorporated by reference herein in its entirety.

For example, an entrained polymer film material made from a monolithic material comprising a base polymer (e.g., a thermoplastic polymer, such as a polyolefin), a channeling agent (e.g., polyethylene glycol) and an antimicrobial gas releasing agent, may be provided within the container. Preferably, the film is secured to the sidewall above a midpoint or is secured (or part of) the underside of the lid.

Optionally, an antimicrobial releasing agent is disposed within the internal compartment, the antimicrobial releasing agent releasing chlorine dioxide gas into the product containing space by reaction of moisture with the antimicrobial releasing agent. The antimicrobial releasing agent is optionally provided in an amount that releases the chlorine dioxide gas to provide a headspace concentration of from 10 parts per million (PPM) to 35 PPM for a period of 16 hours to 36 hours, optionally from 15 PPM to 30 PPM for a period of 16 hours to 36 hours, optionally from 15 PPM to 30 PPM for a period of about 24 hours. Optionally, the antimicrobial releasing agent is a powdered mixture comprising an alkaline metal chlorite, preferably sodium chlorite. Optionally, the powdered mixture further comprises at least one catalyst, optionally sulfuric acid clay, and at least one humidity trigger, optionally calcium chloride.

As used herein, the term “channeling agent” or “channeling agents” is defined as a material that is immiscible with the base polymer and has an affinity to transport a gas phase substance at a faster rate than the base polymer. Optionally, a channeling agent is capable of forming channels through the entrained polymer when formed by mixing the channeling agent with the base polymer. Channeling agents form channels between the surface of the entrained polymer and its interior to transmit moisture into the film to trigger the antimicrobial gas releasing agent and then to allow for such gas to emit into the container.

It has been found that methods according to the disclosed concepts provide a surprisingly long shelf life to the products. The term “shelf life” as used herein with reference to fresh product is the length of time (measured in days) that the product may be stored in above-freezing conditions without becoming unfit for consumption. Optionally, in any embodiment, fresh product may be previously frozen. The term “product” as used herein may include, without limitation, scallops, octopus, squid, oysters, optionally live oysters, mussels, optionally live mussels, clams, optionally live clams, mollusks, fruit, vegetables, meat, optionally chicken, and/or flowers or other plant life.

### Recitation of Exemplary Embodiments

The following exemplary embodiments further describe optional aspects of the presently disclosed technology and are part of this Detailed Description. These exemplary embodiments are set forth in a format substantially akin to claims (each with numerical designations followed by the letter A or B), although they are not technically claims of the present application. The following exemplary embodiments refer to each other in dependent relationships as “embodiments” instead of “claims.”

1A. A method of packaging and/or preserving product comprising: placing product in a product containing space of a container atop a platform of a support structure, the container comprising an internal compartment having the product containing space, the support structure defining the platform for supporting the product, the internal compartment further comprising a reservoir below the platform, the reservoir being configured to retain liquid, at least one of the platform or the support structure being configured to direct liquid exuded from the product to the reservoir.

2A. The method of embodiment 1A, the support structure defining the platform located above the reservoir, the support structure and/or the platform comprising one or more of:
a. a liquid permeable surface;
b. one or more openings; and
c. a ramp providing for liquid runoff from a side of the platform;
wherein the one or more of the liquid permeable surface, the one or more openings and the ramp providing for liquid runoff from a side of the platform are configured to direct liquid exuded from the product into the reservoir.

3A. The method of embodiment 1A or 2A, wherein the support structure and/or the platform comprising a liquid permeable surface made from a nonwoven material.

4A. The method of any one of embodiments 1A to 3A, further comprising an absorbent material in the reservoir.

5A. The method of any one of embodiments 1A to 4A, and optionally of embodiment 4A, wherein the absorbent material comprises a gel-forming polymer.

6A. The method of any one of embodiments 1A to 5A, and optionally of embodiment 5A, wherein the gel-forming polymer is a food safe non-crosslinked water-soluble polymer having a first absorbency, the first absorbency being defined by weight of liquid absorbed/weight of the at least one gel-forming polymer.

7A. The method of any one of embodiments 1A to 6A, and optionally of embodiment 6A, wherein the absorbent material further comprises at least one food safe mineral composition having a second absorbency, the second absorbency being defined by weight of liquid absorbed/weight of the at least one mineral composition, the absorbency of the absorbent material exceeding the first absorbency and the second absorbency.

8A. The method of any one of embodiments 1A to 7A, and optionally of embodiment 6A, further comprising at least one food safe soluble salt having at least one trivalent cation.

9A. The method of any one of embodiments 4A to 8A, the absorbent material comprising:
a. at least one food safe non-crosslinked gel-forming water-soluble polymer having a first absorbency, the first absorbency being defined by weight of liquid absorbed/weight of the at least one non-crosslinked gel forming polymer;
b. at least one food safe mineral composition having a second absorbency, the second absorbency being defined by weight of liquid absorbed/weight of the at least one mineral composition; and
c. at least one food safe soluble salt having at least one trivalent cation, the absorbency of the absorbent material exceeding a sum of the first absorbency and the second absorbency.

10A. The method of any one of embodiments 4A to 9A, wherein the absorbent material comprises one or more odor absorbers optionally selected from the group consisting of: zinc chloride, zinc oxide and citric acid.

11A. The method of any one of embodiments 4A to 10A, wherein the absorbent material comprises at least one antimicrobial agent, optionally at least one volatile antimicrobial agent and at least one non-volatile antimicrobial agent.

12A. The method of any one of embodiments 1A to 3A, wherein the reservoir is devoid of absorbent material.

13A. The method of any one of embodiments 1A to 12A, the container further comprising a lid enclosing the product within the product containing space.

14A. The method of any one of embodiments 1A to 13A, and optionally of embodiment 13A, wherein the lid comprises an oxygen permeable lidding film.

15A. The method of any one of embodiments 1A to 14A, the container further comprising an entrained polymer film material disposed within the internal compartment and made from a monolithic material comprising a base polymer, a channeling agent and a chlorine dioxide releasing agent.

16A. The method of any one of embodiments 1A to 15A, and optionally of embodiment 15A, wherein the antimicrobial releasing agent releases chlorine dioxide gas into the product containing space by reaction of moisture with the antimicrobial releasing agent.

1B. A method of packaging and preserving product comprising:
a. providing a container that defines an internal compartment, the internal compartment comprising a reservoir and a product containing space above the reservoir, the container comprising:
   i. a base and a sidewall extending upwardly from the base, the base and at least a portion of the sidewall extending therefrom defining the reservoir, the reservoir being configured to retain liquid; and
   ii. a support structure disposed within the internal compartment, the support structure defining a platform located above the reservoir, the support structure and/or platform comprising one or more of:
      aa. a liquid permeable surface;
      bb. one or more openings; and
      cc. a ramp providing for liquid runoff from a side of the platform;
wherein the one or more of the liquid permeable surface, the one or more openings and the ramp providing for liquid runoff from a side of the platform are configured to direct liquid exuded from the product into the reservoir; and
b. placing the product in the container atop the platform.

2B. The method of embodiment 1B, wherein the support structure and/or the platform comprise a liquid permeable surface made from a nonwoven material.

3B. The method of embodiments 1B or 2B, further comprising an absorbent material in the reservoir.

4B. The method of embodiment 1B, 2B or 3B, and optionally of embodiment 3B, wherein the absorbent material comprises a gel-forming polymer.

5B. The method of embodiment 4B, wherein the gel-forming polymer is a food safe non-crosslinked water-soluble polymer having a first absorbency, the first absorbency being defined by weight of liquid absorbed/weight of the at least one gel-forming polymer.

6B. The method of embodiment 5B, wherein the absorbent material further comprises at least one food safe mineral composition having a second absorbency, the second absorbency being defined by weight of liquid absorbed/weight of the at least one mineral composition, the absorbency of the absorbent material exceeding the first absorbency and the second absorbency.

7B. The method of embodiment 5B, further comprising at least one food safe soluble salt having at least one trivalent cation.

8B. The method of any one of embodiments 3B to 7B, the absorbent material comprising:
a. at least one food safe non-crosslinked gel-forming water-soluble polymer having a first absorbency, the first absorbency being defined by weight of liquid absorbed/weight of the at least one non-crosslinked gel forming polymer;
b. at least one food safe mineral composition having a second absorbency, the second absorbency being defined by weight of liquid absorbed/weight of the at least one mineral composition; and
c. at least one food safe soluble salt having at least one trivalent cation, the absorbency of the absorbent material exceeding a sum of the first absorbency and the second absorbency.

9B. The method of embodiments 3B to 8B, wherein the absorbent material comprises one or more odor absorbers optionally selected from the group consisting of: zinc chloride, zinc oxide and citric acid.

10B. The method of embodiments 3B to 9B, wherein the absorbent material comprises at least one antimicrobial agent, optionally at least one volatile antimicrobial agent and at least one non-volatile antimicrobial agent.

11B. The method of any one of embodiment 1B to 10B, wherein the reservoir is devoid of absorbent material.

12B. The method of any one of embodiments 1B to 11B, wherein the container further comprising a lid enclosing the product within the product containing space.

13B. The method of embodiment 12B, wherein the lid comprises an oxygen permeable lidding film.

14B. The method of embodiment 12B or 13B, wherein the container further comprises an entrained polymer film material disposed within the internal compartment and made from a monolithic material comprising a base polymer, a channeling agent and a chlorine dioxide releasing agent.

15B. The method of embodiment 14B, wherein the antimicrobial releasing agent releases chlorine dioxide gas into the product containing space by reaction of moisture with the antimicrobial releasing agent.

16B. The method of any previous embodiment, wherein the method provides a shelf life for the product when stored in refrigerated conditions, of at least 9 days, optionally at least 12 days, optionally from 12 to 21 days, optionally from 12 to 18 days, optionally from 15 to 21 days, optionally from 15 to 18 days, optionally for 12 days, optionally for 13 days, optionally for 14 days, optionally for 15 days, optionally for 16 days, optionally for 17 days, optionally for 18 days, optionally for 19 days, optionally for 20 days, optionally for 21 days.

While the presently disclosed technology has been described in detail and with reference to specific examples thereof, it will be apparent to one skilled in the art that various changes and modifications can be made therein without departing from the spirit and scope thereof. It is understood, therefore, that the presently disclosed technology is not limited to the particular embodiments disclosed, but it is intended to cover modifications within the spirit and scope of the present presently disclosed technology as defined by the appended claims.

1. A container configured to preserve, store or ship a liquid-exuding product in a product containing space within the container, the container including a thermoformed polymer tray comprising an internal compartment having a product containing space and a support structure defining a platform for supporting a liquid-exuding product, the support structure being separable from the thermoformed polymer tray, corrugated, and formed of a non-woven material that is liquid permeable, the internal compartment further comprising a reservoir below the platform, the reservoir being configured to retain liquid, at least one of the platform or the support structure being configured to direct liquid exuded from the product to the reservoir.

2. (canceled)

3. (canceled)

4. The container of claim 1, wherein the support structure comprises a plurality of spaced ribs extending across a base of the container from one end to an opposite opposing end, and wherein the ribs comprise a plurality of peaks with a plurality of valleys disposed therebetween.

5. The container of claim 1, wherein the reservoir is provided as one single or uninterrupted compartment occupying substantially an entire base of the container.

6. (canceled)

7. (canceled)

8. The container of claim 1, wherein the container includes the liquid-exuding product.

9. The container of claim 1, wherein the liquid-exuding product consists of one of fruit, vegetables, meat, seafood or flowers.

10. The container of claim 1, further comprising absorbent material located in the reservoir.

11. The container of claim 8, further comprising a lid disposed over an opening to the container to enclose the product within the product containing space.

12. (canceled)

13. A method of preserving, storing or shipping liquid-exuding product, the method comprising:
placing liquid-exuding product in a product containing space of a container atop a platform of a support structure, the container including a thermoformed polymer tray comprising an internal compartment having the product containing space, the support structure defining the platform for supporting the product, the support structure being separable from the thermoformed polymer tray, corrugated, and formed of a non-woven material that is liquid permeable, the internal compartment further comprising a reservoir below the platform, the reservoir being configured to retain liquid, at least one of the platform or the support structure being configured to direct liquid exuded from the product to the reservoir.

14. (canceled)

15. (canceled)

16. The method of claim 13, further comprising absorbent material located in the reservoir.

17. The method of claim 16, wherein the absorbent material comprises a gel-forming polymer.

18. The container of claim 1, wherein the non-woven material of the support structure is rigid.

19. The container of claim 4, wherein absorbent material is located within the plurality of peaks of the support structure.

20. The container of claim 1, wherein no absorbent material is located in the reservoir.

21. The method of claim 16, the absorbent material is located within the plurality of peaks of the support structure.

22. The method of claim 13, wherein no absorbent material is located in the reservoir.

23. A container configured to preserve, store, or ship a liquid-exuding product in a product containing space within the container, the container comprising:
a tray having a side wall extending upwardly from a bottom wall, at least one rib extending upwardly from the bottom wall, the at least one rib forming at least two wells within the tray; and
a support structure located within at least one of the wells, the support structure including absorbent material therein and a permeable filter or membrane enclosing the absorbent material within the support structure.

24. The container of claim 23, wherein the support structure is removably placed within the at least one of the wells.

25. The container of claim 23, wherein a height of the support structure is less than a height of the side wall.

26. The container of claim 25, wherein a height of the at least one rib is at least slightly less than the height of the support structure.

27. The container of claim 25, wherein a bottom surface of a ledge of the support structure rests on a top surface of the at least one rib.
